(19) United States
(12) Patent Application Publication
(10) Pub. No.: US 2011/0110262 A1
(43) Pub. Date: May 12, 2011

(54) DOWNLINK RECEIVING STATUS FEEDBACK METHOD

(76) Inventors: Bin Yu, Shenzhen (CN); Zhongda Du, Shenzhen (CN)

(21) Appl. No.: 13/003,144

(22) PCT Filed: Jun. 30, 2009
(86) PCT No.: PCT/CN09/72556

§ 371 Date: Jan. 7, 2011

(30) Foreign Application Priority Data
Jul. 25, 2008 (CN) 200810133275.7

(51) Int. Cl. H04L 12/26

(52) U.S. Cl. 370/252

(57) ABSTRACT

A downlink receiving status feedback method is disclosed. The method comprises: a control parameter, which is used for indicating a feedback mode used by a terminal for feeding back downlink receiving status, is carried in a radio resource control (RRC) signaling which is transmitted to the terminal (1) by a base station (2). The terminal feeds data receiving status corresponding to PDSCHs in multiple downlink sub-frames back to the base station in one uplink sub-frame according to the current feedback mode, current configurations of uplink sub-frames and downlink sub-frames, and an uplink feedback timing relation defined by a system.

### TECHNICAL FIELD

The present disclosure relates to the field of wireless communication, and in particular to a downlink receiving status feedback method.

### BACKGROUND

FIG. 1 shows a frame structure in a time division duplex (TDD) mode in a long term evolution (LTE) system, in which a radio frame of 10 ms is divided into two half-frames, each half-frame is divided into 10 time slots equally of 0.5 ms, and two time slots form a sub-frame of 1 ms. One half-frame includes 5 sub-frames. In the frame structure, the configuration of the sub-frame has the following characteristics:

(1) sub-frame 0 is always reserved for downlink;

(2) sub-frame 1 (hereinafter referred to as a special sub-frame) includes 3 special time slots which are a downlink pilot time slot (DwPTS), a guard period (GP) and an uplink pilot time slot (UpPTS), wherein

DwPTS is used for downlink and capable of transmitting primary-synchronization channel (P-SCH) signals, physical downlink shared channel (PDSCH) signals and the like;

GP is guard time, in which no data is transmitted;

UpPTS is used for uplink and capable of transmitting random access channel (RACH) signals, sounding reference signals and the like;

(3) sub-frame 2 is always reserved for uplink transmission.

The frame structure can support various configurations of different uplink/downlink ratio, the following Table 1 shows 7 kinds of uplink/downlink sub-frame configurations provided by the current LTE TDD, wherein DL/D represents downlink, UL/U represents uplink, and S represents a special sub-frame. For instance, in configuration 1, sub-frame 2, 3, 7 and 8 are used for uplink transmission, sub-frame 0, 4, 5 and 9 are used for downlink transmission, and part symbols in DwPTS of special sub-frame 1 and 6 are also used for downlink transmission.

TABLE 1

| DL/UL | Switch | | | | | | | | | | | |
|---|---|---|---|---|---|---|---|---|---|---|---|---|
| sub-frame | point | | Sub-frame number | | | | | | | | | |
| configuration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 10 | ms | D | S | U | U | U | D | S | U | U | D |

In the LTE TDD system, due to unavoidable hardware processing delay and TDD characteristic, transmission timing for downlink receiving status acknowledgement (ACK) and negative-acknowledgement (NACK) fed back in uplink, or transmission timing for discontinuous transmission (DTX for short, which may be fed back implicitly, or replaced by NACK, or fed back explicitly) status generated by the loss of a downlink control signaling, should be pre-configured. It is defined in the current LTE TDD that the receiving status feedback information ACK/NACK corresponding to a physical downlink shared channel (PDSCH) in a downlink sub-frame n should be fed back by a terminal in an uplink sub-frame of n+k (k>3). The value of the variable k is determined by n and DL/UL sub-frame configuration, the following Table 2 shows the value of the uplink feedback timing index k corresponding to a downlink sub-frame n in different DL/UL sub-frame configurations.

TABLE 2

| DL/UL | | | | | | | | | | |
|---|---|---|---|---|---|---|---|---|---|---|
| sub-frame | Downlink sub-frame number n | | | | | | | | | |
| configuration | 0 | 1 | 2 | 3 | 4 | 5 | 6 | 7 | 8 | 9 |
| 0 | 4 | 6 | — | — | — | 4 | 6 | — | — | — |
| 1 | 7 | 6 | — | — | 4 | 7 | 6 | — | — | 4 |
| 2 | 7 | 6 | — | 4 | 8 | 7 | 6 | — | 4 | 8 |
| 3 | 4 | 11 | — | — | — | 7 | 6 | 6 | 5 | 5 |
| 4 | 12 | 11 | — | — | 8 | 7 | 7 | 6 | 5 | 4 |
| 5 | 12 | 11 | — | 9 | 8 | 7 | 6 | 5 | 4 | 13 |
| 6 | 7 | 7 | — | — | — | 7 | 7 | — | — | 5 |

In the LTE TDD system, it can be seen from Table 1 that in some DL/UL configurations there are more downlink sub-frames than uplink sub-frames, namely, an uplink sub-frame needs to feed back the ACK/NACK information corresponding to PDSCHs in multiple downlink sub-frames, the following Table 3 shows the possible maximum number of the ACK/NACK messages corresponding to PDSCHs which needs to be fed back in each uplink sub-frame when the DUUL sub-frame configuration is as shown in Table 1.

TABLE 3

| DL/UL | Switch | | | | | | | | | | | |
|---|---|---|---|---|---|---|---|---|---|---|---|---|
| sub-frame | point | | Sub-frame number | | | | | | | | | |
| configuration | periodicity | | 0 | 1 | 2 | 3 | 4 | 5 | 6 | 7 | 8 | 9 |
| 0 | 5 | ms | — | — | 1 | 0 | 1 | — | — | 1 | 0 | 1 |
| 1 | 5 | ms | — | — | 2 | 1 | — | — | — | 2 | 1 | — |
| 2 | 5 | ms | — | — | 4 | — | — | — | — | 4 | — | — |
| 3 | 10 | ms | — | — | 3 | 2 | 2 | — | — | — | — | — |
| 4 | 10 | ms | — | — | 4 | 4 | — | — | — | — | — | — |
| 5 | 10 | ms | — | — | 9 | — | — | — | — | — | — | — |
| 6 | 10 | ms | — | — | 1 | 1 | 1 | — | — | 1 | 1 | — |

As LTE uplink should meet the characteristic of single carrier, a problem which is must be solved is how to feed back the ACK/NACK information corresponding to receiving status over PDSCHs in multiple downlink sub-frames on one physical uplink control channel (PUCCH) resource when the number of downlink sub-frames is configured to be more than the number of uplink sub-frames. Herein, the PUCCH resource refers to a minimum physical resource for carrying an uplink control signaling, namely, a physical resource block (RB) defined in the current LTE. Additionally, it is defined in the LTE system that the downlink receiving status ACK/NACK is transmitted over a physical uplink shared channel (PUSCH) when a terminal has distributed PUSCH resources for a feedback sub-frame, and similarly, it should still be considered how to feed back the ACK/NACK information corresponding to receiving status over PDSCHs in multiple downlink sub-frames over the PUSCH occupied by the terminal. In order to solve the problem existing in the terminal of the LTE TDD system of transmitting multiple ACK/NACK bits in one sub-frame, the current LTE TDD system introduces an acknowledgement information bundling (ACK/NACK bundling) feedback mode for multiple downlink sub-frames, namely, according to the defined uplink/downlink transmission timing relation, the data receiving status information ACK/NACK corresponding to PDSCHs in multiple downlink scheduling sub-frames which needs to be fed back by a terminal in one uplink sub-frame are bundled, and for a spatial data stream (also known as codeword stream) a logic “AND” operation is performed on the receiving status information corresponding to multiple downlink sub-frames to form a bundled ACK/NACK bit as the feedback on multiple downlink receiving status (at most one ACK/NACK bit can be fed back in the uplink sub-frame as the feedback on multiple downlink data receiving status). As shown in FIG. 2, when the PDSCH adopts single-stream transmission, a logic “AND” operation is performed on the ACK/NACK bits corresponding to multiple downlink sub-frames to produce one ACK/NACK bit to transmit; and format 1a (PUCCH format 1a) defined in the LTE system can be used if PUCCH transmission is adopted. As shown in FIG. 3, when PDSCH adopts dual-stream transmission, for each codeword stream, a logic “AND” operation is performed on ACK/NACK corresponding to multiple downlink sub-frames to produce one bundled ACK/NACK bit, then the two bits produced by the dual-streams may adopt a format 1b (PUCCH format 1b) in PUCCH transmission.

However, the adoption of the ACK/NACK bundling brings about a lot of unnecessary retransmission and seriously lowers system throughput. That is, as long as the PDSCH in only one downlink sub-frame corresponds to an acknowledgement message of NACK, result is NACK, then the base station needs to retransmit PDSCH data in all downlink sub-frames for a terminal; and only if the acknowledgement messages to which the PDSCHs in all downlink sub-frames correspond are all ACK, the result is ACK, which indicates that the PDSCHs in all downlink sub-frames are correctly received. In order to improve system throughput to meet the requirement on frequency spectrum utilization is rate, it is absolutely necessary to consider, based on the ACK/NACK bundling, an acknowledgement information multiplexing (ACK/NACK multiplexing) feedback mode for multiple downlink sub-frames, in which when a terminal needs to feed back the receiving status information ACK/NACK corresponding to PDSCHs in multiple sub-frames in one uplink sub-frame, the ACK/NACK bits corresponding to different downlink sub-frames are synchronously transmitted in one uplink sub-frame by certain means of multiplexing; and when the terminal needs to feed back the receiving status corresponding to multiple downlink sub-frames in one uplink sub-frame, it feeds back the receiving status corresponding to each downlink sub-frame separately in the uplink sub-frame by means of multiplexing instead of performing any “AND” operation on the receiving status corresponding to different downlink sub-frames. As shown in FIG. 4, when a terminal needs to feed back ACK/NACK corresponding to 4 downlink PDSCHs in certain uplink sub-frame, each downlink PDSCH may correspond to one ACK/NACK bit (only 1 bit is fed back if dual-stream is adopted, and bundling should be carried out first if spatial codeword stream is adopted), and the 4 ACK/NACK bits may be multiplexed on PUCCH or PUSCH by means of code division and the like.

However, the disadvantage of ACK/NACK multiplexing is that the uplink coverage is limited when the ACK/NACK bits multiplexed on PUCCH are increased. Considering both uplink coverage and throughput, it is concluded that the LTE TDD system had better support two feedback modes of multiple ACK/NACK bits, namely, the ACK/NACK bundling mode for multiple downlink sub-frames and the ACK/NACK multiplexing mode for multiple downlink sub-frames, and in each of the two modes, only one feedback mechanism needs to be defined in order to reduce control signaling overhead, and the system can choose one mode of the two. It is known from the analysis above that if the LTE TDD system supports the two modes, there must be an effective way in the system for configuring the two modes to improve the performance and the efficiency of the LTE TDD system.

### SUMMARY

The present disclosure aims to provide a downlink receiving status feedback method, which makes a system flexibly configure an appropriate mode to feed back downlink receiving status.

In order to address the problem above, the disclosure provides a downlink receiving status feedback method which comprises: a control parameter, which is used for indicating a feedback mode used for a terminal to feed back downlink receiving status feedback, is carried in an RRC signaling which is transmitted to the terminal by a base station; and the terminal feeds data receiving status corresponding to PDSCHs in multiple downlink sub-frames back to the base station in one uplink sub-frame according to the feedback mode, current configurations of uplink sub-frames and downlink sub-frames, and an uplink feedback timing relation defined by a system.

Further, the feedback mode may be an ACK/NACK bundling mode for multiple downlink sub-frames or an ACK/NACK multiplexing mode for multiple downlink sub-frames.

Further, the base station may determine the feedback mode used for the downlink receiving status feedback according to uplink signal quality of the terminal, and if the uplink signal quality is lower than a preset threshold, according to the control parameter the base station may indicate the terminal to use the ACK/NACK bundling mode for multiple downlink sub-frames when it feeds back the downlink receiving status; and if the uplink signal quality is equal to or higher than the preset threshold, according to the control parameter the base station may indicate the terminal to use the ACK/NACK multiplexing mode for multiple downlink sub-frames when it feeds back the downlink receiving status.

Further, the uplink signal quality may be represented by uplink signal intensity.

Further, after receiving the control parameter indicating the ACK/NACK bundling mode for multiple downlink sub-frames, according to the current configurations of uplink sub-frames and downlink sub-frames, the terminal may look up an uplink sub-frame for feedback in a feedback timing relation table pre-defined by the system; and the terminal may perform a logic “AND” operation on data receiving status AMNACK information corresponding to PDSCHs in multiple downlink sub-frames to bundle the information into ACK/NACK information of 1 bit, and may transmit the ACK/NACK bit to the base station in a corresponding uplink sub-frame.

Further, after receiving the control parameter indicating the ACK/NACK multiplexing mode for multiple downlink sub-frames, according to the current configurations of uplink sub-frames and downlink sub-frames, the terminal may look up an uplink sub-frame for feedback in a feedback timing relation table pre-defined by the system; and the terminal may transmit data receiving status ACK/NACK information corresponding to PDSCHs in multiple downlink sub-frames in a corresponding uplink sub-frame to the base station by means of multiplexing.

Further, the RRC signaling may include an RRC connection reconfiguration message and an RRC connection setup message.

Further, the control parameter may be carried in a PUCCH dedicated configuration information element of an RRC connection reconfiguration message or an RRC connection setup message.

Further, the base station may set a control parameter of 1 bit and may respectively represent each corresponding feedback mode used for the downlink receiving status feedback with each value.

Further, the downlink receiving status feedback method may be applied to time division duplex mode in a long term evolution system in which there are more downlink sub-frames are than uplink sub-frames.

Compared with the prior art, the disclosure enables a system to flexibly configure an appropriate mode to feed back downlink receiving status, and a base station can configure an ACK/NACK bundling mode or an ACK/NACK multiplexing mode for any UE in a cell; for a UE located at edge of a cell or having weak feedback signal, the base station indicates, according to its own determining criterion, the UE which needs to feed back multiple ACK/NACK bits to use the ACK/NACK bundling to guarantee the uplink signal receiving performance when the UE feeds back downlink receiving status, while indicates a UE located in the center of the cell or having excellent channel condition to use ACK/NACK multiplexing to increase throughput.

### BRIEF DESCRIPTION OF THE DRAWINGS

FIG. 1 is a figure of a frame structure adopted by the LTE TDD in the prior art;

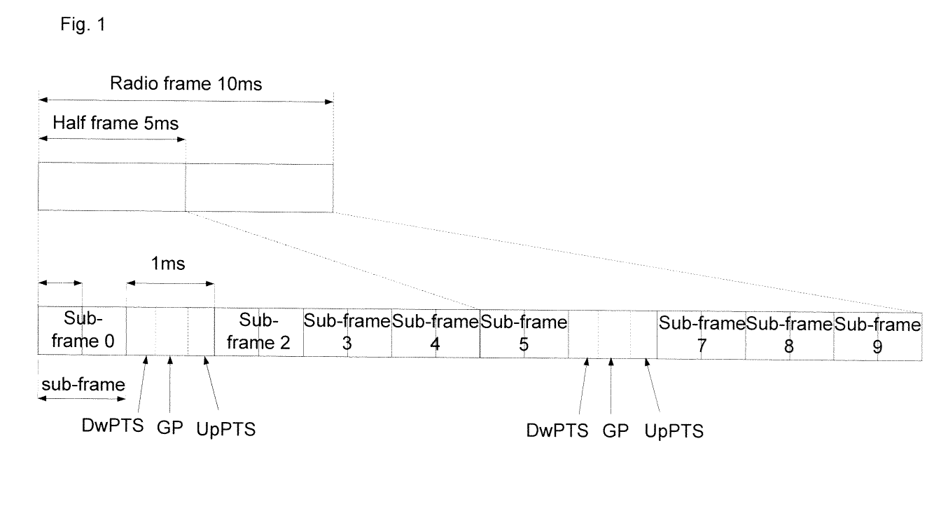

FIG. 2 is a figure of the realization of the multiple ACK/NACK bits feedback using ACK/NACK bundling in the case of single-stream;

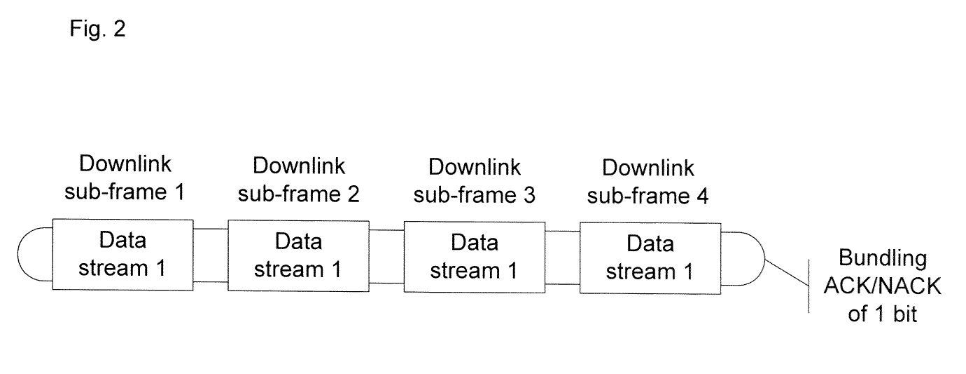

FIG. 3 is a figure of the realization of the multiple ACK/NACK bits feedback using ACK/NACK bundling in the case of dual-stream;

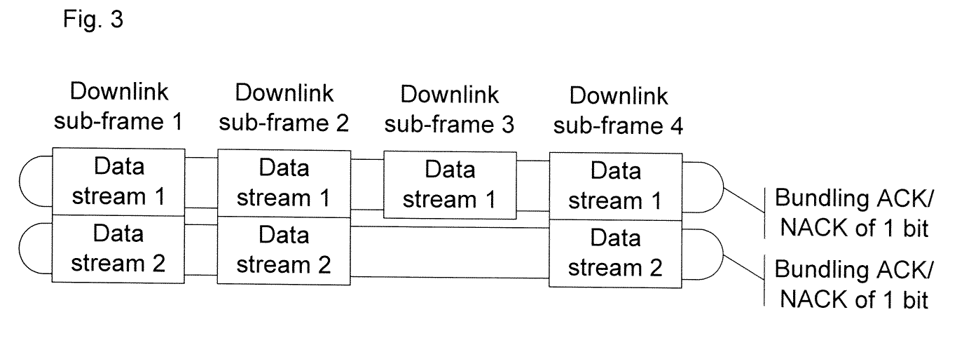

FIG. 4 is a figure of ACK/NACK multiplexing in the case of dual-stream;

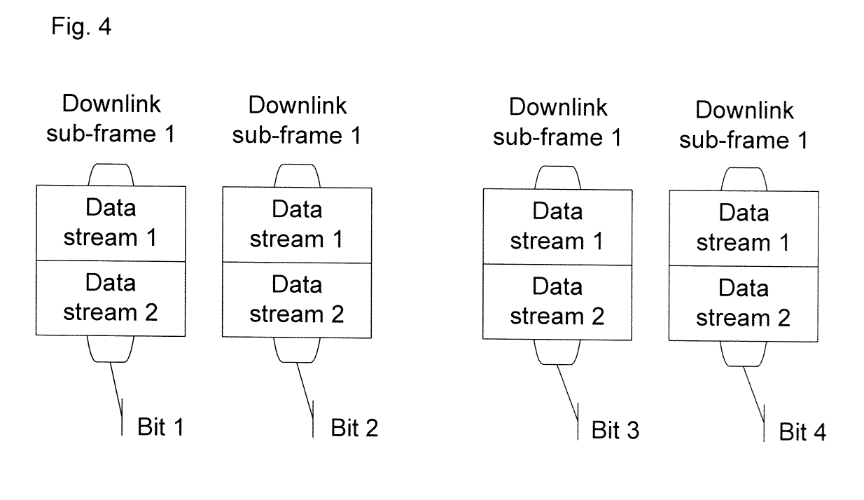

FIG. 5 is a signaling flowchart for a base station to configure a downlink receiving status feedback mode of a terminal in an embodiment of the disclosure;

FIG. 6 is a diagram of the application of the disclosure.

### DETAILED DESCRIPTION

In order to overcome the shortcomings of the conventional technical scheme, a downlink receiving status feedback method of the disclosure is further described by referring to the following embodiments, and the content hereinafter is for describing the embodiments in detail but not for limiting the disclosure.

The disclosure is applicable to the case in which there are more downlink sub-frames than uplink sub-frames in DL/UL sub-frame configuration in the LTE TDD system, that is, applicable to the case in which an uplink sub-frame may need to feed back multiple downlink receiving status, namely, the DL/UL sub-frame configuration in the LTE TDD system is shown in items numbered 1-5 (referring to Table 1).

First, a system sets a control parameter carried in an RRC signaling (for example, RRC connection reconfiguration message, RRC connection setup message and the like) to inform a terminal of a feedback mode used for a downlink receiving status feedback when a base station transmits downlink data to the terminal.

The base station determines a feedback mode used for a downlink receiving status feedback according to uplink signal quality of the terminal; and the uplink signal quality may be obtained by existing means, for example, obtained according to uplink signal intensity parameter.

For a UE located at edge of a cell or having weak uplink signal (uplink signal quality is lower than a preset threshold), the base station indicates the UE to use an ACK/NACK bundling mode via the control parameter to guarantee uplink signal receiving performance when UE feeds back downlink receiving status, and the base station indicates a UE located in the center of the cell or having excellent channel condition (uplink signal quality is equal to or higher than the present threshold) to use an ACK/NACK multiplexing via the control parameter to increase throughput.

In specific application the control parameter is carried in PUCCH configuration information element of the current structure in an RRC connection reconfiguration message or an RRC connection setup message; and the PUCCH dedicated configuration information element is a terminal-dedicated information element.

For instance, if the parameter is set to be 1 bit, 0 represents the adoption of the ACK/NACK bundling and 1 represents the adoption of the AMNACK multiplexing; or 0 represents the adoption of the ACK/NACK multiplexing and 1 represents the adoption of the ACK/NACK bundling. The value-taking manner of the feedback mode control parameter has no limitation on the present patent. The following embodiments are described based on the first value-taking manner: 0 represents the adoption of ACK/NACK bundling, and 1 represents the adoption of ACK/NACK multiplexing.

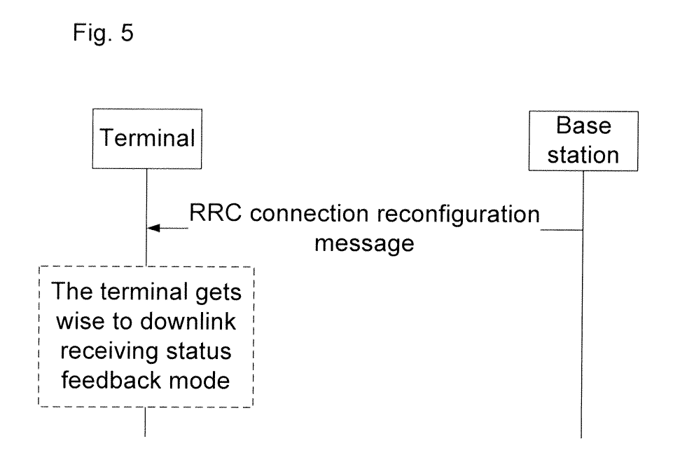

FIG. 5 is a signaling flowchart for a base station to configure a downlink receiving status feedback mode of a terminal in an embodiment of the disclosure. When the base station in a cell schedules PDSCHs in multiple downlink sub-frames to a UE, the UE gets wise to feedback mode it should adopt by receiving and reading a control parameter contained in an RRC signaling (for example, RRC connection reconfiguration message, RRC connection setup message and the like) transmitted from the base station and performs feedback in a given uplink sub-frame according to the uplink feedback timing relation (shown in Table 2 and Table 3) and the known feedback mode.

The disclosure is described by reference to the following application example. An uplink feedback timing relation (referring to Table 2) is pre-configured in the LTE TDD system, and a UE gets wise to configurations of uplink sub-frames and downlink sub-frames according to system information transmitted from a base station (referring to Table 1 and taking the DL/UL sub-frame configuration numbered 4 for example).

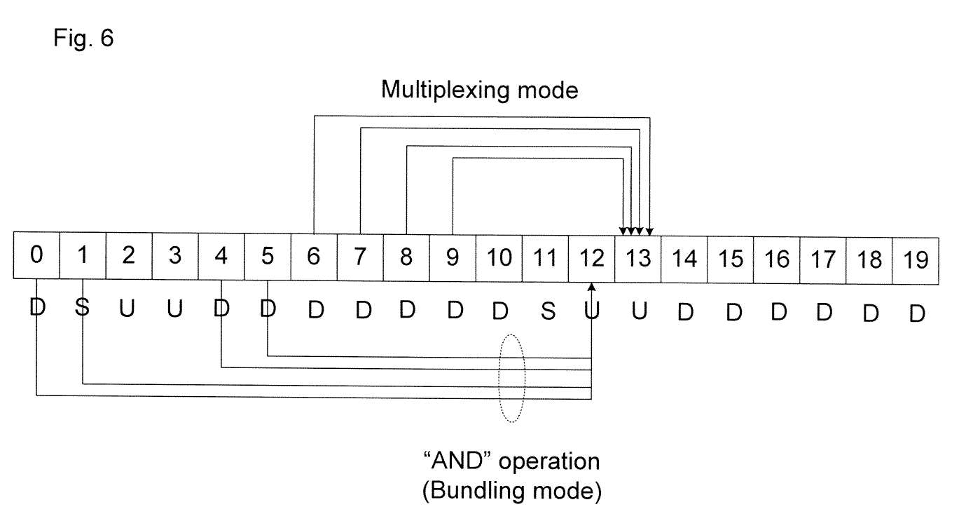

As shown in FIG. 6 (for the sake of explanation, the sub-frames of two radio frames are numbered in the figure, namely, 20 sub-frames are numbered from 0-19), providing that all PDSCHs in downlink sub-frame 0, 1, 4 and 5 are scheduled for data transmission of UE1 and single-stream transmission is adopted, and PDSCHs in downlink sub-frames 6, 7, 8 and 9 are scheduled for data transmission of UE2 and single-stream transmission is adopted, the UE generates a downlink receiving status ACK/NACK message of 1 bit according to receiving situation of the PDSCH in each sub-frame.

UE1 gets wise to the value of feedback mode control parameter being 0 by receiving and reading a control parameter in an RRC connection reconfiguration message, that is, UE1 should adopt bundling mode, then UE1 performs a logic “AND” operation on uplink sub-frame 12 to combine downlink receiving status ACK/NACK messages of 4 bits into an ACK/NACK of 1 bit according to a system-defined feedback timing relation (referring to DL/UL sub-frame configuration numbered 4 in Table 2, the value of n+K of each of sub-frame 0, 1, 4 and 5 is 12) and feeds back the combined ACK/NACK. Here, if receiving status corresponding to one downlink sub-frame is NACK, the UE feeds back a NACK of 1 bit by performing a logic “AND” operation, and the base station retransmits data which is previously transmitted in the 4 downlink sub-frames. It is apparent that the bundling mode, which may cause unnecessary retransmission and lower throughout, is applicable to cell-edge users.

UE2 gets wise to the value of feedback mode control parameter being 1 by receiving and reading a control parameter in an RRC connection reconfiguration message, that is, UE2 should adopt multiplexing mode, then UE2 feeds back downlink receiving status ACK/NACK messages of 4 bits in uplink sub-frame 13 by using existing multiplexing is method (for example time division multiplexing, space division multiplexing and the like) according to a feedback timing relation (referring to DL/UL sub-frame configuration numbered 4 in Table 2, the value of n+K of each of sub-frame 6, 7, 8 and 9 is 13) pre-defined by the system. If the receiving status corresponding to downlink sub-frame 6 is NACK, data in downlink sub-frame 6 is retransmitted, causing no influence on downlink sub-frame 7, 8 and 9. It is apparent that the multiplexing mode does not lower throughout seriously but the multiplexing of multiple ACK/NACK bits decreases uplink coverage.

Thus, by adding a feedback mode control parameter into an RRC dedicated signaling, the base station may flexibly configure a feedback mode for each UE in a cell to make a feedback mode control be UE-specific, so that the throughout and the coverage performance of a system are balanced well.

Of course, the present disclosure may have numbers of other embodiments, various modifications and variations can be devised by those skilled in the art without departing from the scope of this disclosure, and it should be understood that the devised modification and variations belong to the protection scope of the claims disclosed herein.

### INDUSTRIAL APPLICABILITY

According to the downlink receiving status feedback method of the disclosure, a system may flexibly configure an appropriate mode to feed back downlink receiving status. By applying the method, an LTE TDD system can support an ACK/NACK bundling feedback mode for multiple downlink sub-frames and an ACK/NACK multiplexing feedback mode for multiple downlink sub-frames, in each of which only one feedback mechanism is defined to reduce control signaling overhead, thus the disclosure improves the performance and the efficiency of the LTE TDD system, avoids unnecessary retransmission, and increases system throughout.

1. A downlink receiving status feedback method, comprising:
a control parameter, which is used for indicating a feedback mode used for a terminal to feeding back downlink receiving status, being carried in a radio resource control (RRC) signaling which is transmitted to the terminal by a base station; and
the terminal feeding data receiving status corresponding to physical downlink shared channels (PDSCHs) in multiple downlink sub-frames back to the base station in one uplink sub-frame according to the feedback mode, current configurations of uplink sub-frames and downlink sub-frames, and an uplink feedback timing relation defined by a system.

2. The method according to claim 1, wherein the feedback mode is an acknowledgement information bundling (ACK/NACK bundling) mode for multiple downlink sub-frames or an acknowledgement information multiplexing (ACK/NACK multiplexing) mode for multiple downlink sub-frames.

3. The method according to claim 2, further comprising:
the base station determining the feedback mode used for the downlink receiving status feedback according to uplink signal quality of the terminal, and if the uplink signal quality is lower than a preset threshold, according to the control parameter the base station indicating the terminal to use the AMNACK bundling mode for multiple downlink sub-frames when it feeds back the downlink receiving status; and
if the uplink signal quality is equal to or higher than the preset threshold, according to the control parameter the base station indicating the terminal to use the ACK/NACK multiplexing mode for multiple downlink sub-frames when it feeds back the downlink receiving status.

4. The method according to claim 3, wherein the uplink signal quality is represented by uplink signal intensity.

5. The method according to claim 3, further comprising:
after receiving the control parameter indicating the ACK/NACK bundling mode for multiple downlink sub-frames, according to the current configurations of uplink sub-frames and downlink sub-frames, the terminal looking up an uplink sub-frame for feedback in a feedback timing relation table pre-defined by the system; and
the terminal performing a logic “AND” operation on data receiving status ACK/NACK information corresponding to PDSCHs in multiple downlink sub-frames to bundle the information into ACK/NACK information of 1 bit, and transmitting the ACK/NACK bit to the base station in a corresponding uplink sub-frame.

6. The method according to claim 3, further comprising:
after receiving the control parameter indicating the ACK/NACK multiplexing mode for multiple downlink sub-frames, according to the current configurations of uplink sub-frames and downlink sub-frames, the terminal looking up an uplink sub-frame for feedback in a feedback timing relation table pre-defined by the system; and
the terminal transmitting data receiving status ACK/NACK information corresponding to PDSCHs in multiple downlink sub-frames in a corresponding uplink sub-frame to the base station by means of multiplexing.

7. The method according to claim 1, wherein the RRC signaling includes an RRC connection reconfiguration message and an RRC connection setup message.

8. The method according to claim 1, wherein the control parameter is carried in a PUCCH dedicated configuration information element of an RRC connection reconfiguration message or an RRC connection setup message.

9. The method according to claim 2, wherein the base station sets a control parameter of 1 bit and respectively represents each corresponding feedback mode used for the downlink receiving status feedback with each value.

10. The method according to claim 1, wherein the downlink receiving status feedback method is applied to time division duplex mode in a long term evolution system in which there are more downlink sub-frames than uplink sub-frames.
